(19) United States
(12) Patent Application Publication
(10) Pub. No.: US 2017/0174479 A1
(43) Pub. Date: Jun. 22, 2017

(54) CABLE LOGGING SYSTEM

(71) Applicant: AWDON TECHNOLOGIES LIMITED, Gisborne (NZ)

(72) Inventor: Donald Anthony SCOTT, Gisborne (NZ)

(21) Appl. No.: 15/309,308

(22) PCT Filed: Mar. 31, 2015
(86) PCT No.: PCT/NZ2015/050036

§ 371 Date: Nov. 7, 2016

(30) Foreign Application Priority Data
Apr. 9, 2014 (NZ) 623625

(51) Int. Cl. B66C 21/04

(52) U.S. Cl. CPC B66C 21/04

(57) ABSTRACT

A skyline cable logging system in which a skyline carriage runs on a skyline cable (106) between a yarding hauler (101) and a remote mobile tailhold (113) has the remotely controllable mobile tailhold powered and with winch tails which are connected to multiple anchor points (110). With the skyline tensioned so that the mobile tailhold is aerial the winch tails can be varied to traverse the skyline end between anchor points (110). The anchor points (110) can be relocated one at a time to allow the skyline to traverse a large area.

### TECHNICAL FIELD

The invention generally relates to a cable logging system for yarding felled tree stems to a landing area.

More particularly the invention relates to a skyline yarding system in which a skyline tailhold is adapted to position itself by controlling the length of cable tails to anchor points.

### BACKGROUND OF THE INVENTION

In timber felling it is normal to place a log yarding machine (“hauler”) with a tower adjacent to a landing area in which logs will be stacked following retrieval after felling at a logging area. The log hauler tower supports one or more working wire ropes or cables used in retrieving logs and may also anchor several guy ropes used to prevent the hauler from toppling under load.

The working ropes include one to which logs to be retrieved can be secured, allowing the logs to be dragged or carried from the logging area to the landing area. Alternatively a carriage may move along a suspended rope with logs secured to the carriage and another cable may pull the carriage to the landing area.

The working ropes must be anchored to fixed points remotely from the hauler, or must pass through sheaves anchored to fixed points remote from the hauler, and typically these points will be topped standing stems or the stumps of felled trees.

This invention relates to a skyline system having a suspended skyline cable, in which a carriage is fully supported on the skyline cable extending from the hauler tower to, normally, a stump to support the skyline cable clear of the ground in operation. The skyline may run downhill from the hauler allowing the carriage to move down to the logging area under the influence of gravity (“shotgunning”). The carriage may be hauled back to the landing area by the hauler using a second “mainline” rope secured to the carriage.

This provides an area (the “road”) under and adjacent to the skyline cable which can be reached by choker strops or grapples attached to the skyline carriage. The width of the road is limited by the length of the choker strops, which are hand placed, or by the grapple suspension method. It is known to provide a further rope from the hauler to the carriage and deviating from the carriage to an anchor at one side of the road and back to the hauler. This rope may be part of a circulating cable (the “haulback”) from the hauler on pulleys anchored on stumps at the edge of the road allowing the carriage to be pulled towards or away from the hauler or for the carriage and skyline rope to be deviated sideways to effectively widen the road.

Even so the widening of the road requires the constant shifting of the haulback anchor points and much opportunity to tangle ropes and endanger personnel. It would be desirable to widen the area of the road without requiring excessive movement of anchor points to do it.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

### BRIEF SUMMARY OF THE INVENTION

In one exemplification the invention consists in a mobile tailhold for a skyline logging system, the mobile tailhold having at least two mobile tailhold powered winchable cable tails, the cable tails being winchable by at least one mobile tailhold mounted winch, the cable tails each being attachable to an anchoring point such that the mobile tailhold can be positioned relative to the anchor points by winching the cable tails with the at least one mobile tailhold mounted winch.

Preferably the mobile tailhold is attached to a skyline cable and is lifted above the ground in use.

Preferably the mobile tailhold is fixedly attached to a skyline cable as a tailhold.

Preferably the mobile tailhold is movably attached to a skyline cable.

Preferably the mobile tailhold is movable aerially laterally of the skyline cable by shortening one of the mobile tailhold powered winchable cable tails when attached to an anchor point and lengthening another of the mobile tailhold powered winchable cable tails when attached to an anchor point.

Preferably the at least one mobile tailhold mounted winch is a dual drum capstan winch in which the capstan drums counter-rotate and a cable is wrapped in opposing directions around each of the dual drums to provide the winchable cable tails.

Preferably the drums of the dual drum capstan are geared to counter-rotate synchronously.

Preferably the winchable cable tails are winched by separate mobile tailhold powered winches.

Preferably the winchable cable tails exit the tailhold through fairleads which fairleads monitor the cable tail exit angle.

In another exemplification the invention consists in a skyline logging system having at least a skyline cable supported between a hauler and an aerial mobile tailhold, the mobile tailhold being anchorable to at least two separate tail anchor points by cable tails, the mobile tailhold having at least one mobile tailhold powered winch adapted to separately pay out or pull in the cable tails, the mobile tailhold being movable aerially from adjacent one anchor point to adjacent another anchor point by paying out one cable tail and pulling in another cable tail.

Preferably the mobile tailhold has two mobile tailhold powered winches separately controlling the tension in cable tails to two tail anchor points.

Preferably the mobile tailhold has a single anchoring cable with a cable tail extending to each of two different tail anchor points and has a mobile tailhold powered capstan around which an intermediate portion of the cable is wrapped.

Preferably the tailhold has a capstan having two capstan drums and the cable wraps both drums at least once.

Preferably the two capstan drums of the tailhold counter-rotate and the cable wraps in opposite directions around each drum.

Preferably the two capstan drums are geared to counter-rotate synchronously.

Preferably the mobile tailhold is supportable from the skyline cable and is adapted to travel along the skyline cable.
In a further exemplification the invention consists in a lateral deflection jack for a cable logging system, the jack having a frame capable of being attached to an anchor point, at least one pivoted cable receiving shoe pivoted from the frame, the pivotable cable receiving shoe having spaced upper and lower plates, the upper plate having a substantially flat upper surface, the space between the upper and lower plates defining a cable receiving recess, the upper plate being over-rideable by at least one supporting sheave of a carriage, the carriage running on a cable received in the space between the upper and lower plates.

These and other features of as well as advantages which characterise the present invention will be apparent upon reading of the following detailed description and review of the associated drawings.

### BRIEF DESCRIPTION OF THE DRAWINGS

FIG. 1 is a perspective view of a hauler and skyline.

FIG. 2 is a perspective view of the hauler end of the skyline of FIG. 1.

FIG. 3 is a perspective view of the carriage 108 of FIG. 1 from one side.

FIG. 4 is a perspective view of the carriage 108 of FIG. 1 from the other side.

FIG. 5 is a perspective view of a lateral deflection jack used in the skyline system.

FIG. 6 and FIG. 7 show differing perspective views of a lateral deflection jack.

FIG. 8 shows the skyline entraining shoes of a lateral deflection jack.

FIG. 9 shows a view of a carriage passing over a lateral deflection jack

FIG. 10 shows the tail of a skyline secured to a mobile tailhold.

FIG. 11 shows one version of a mobile tailhold.

FIG. 12 shows a side persective view of a second form of mobile tailhold.

FIG. 13 shows a top perspective view of the second form of mobile tailhold.

FIG. 14 shows a perspective view of a third form of mobile tailhold.

FIG. 15 shows a perspective view of a fourth form of mobile tailhold.

### DESCRIPTION OF THE INVENTION

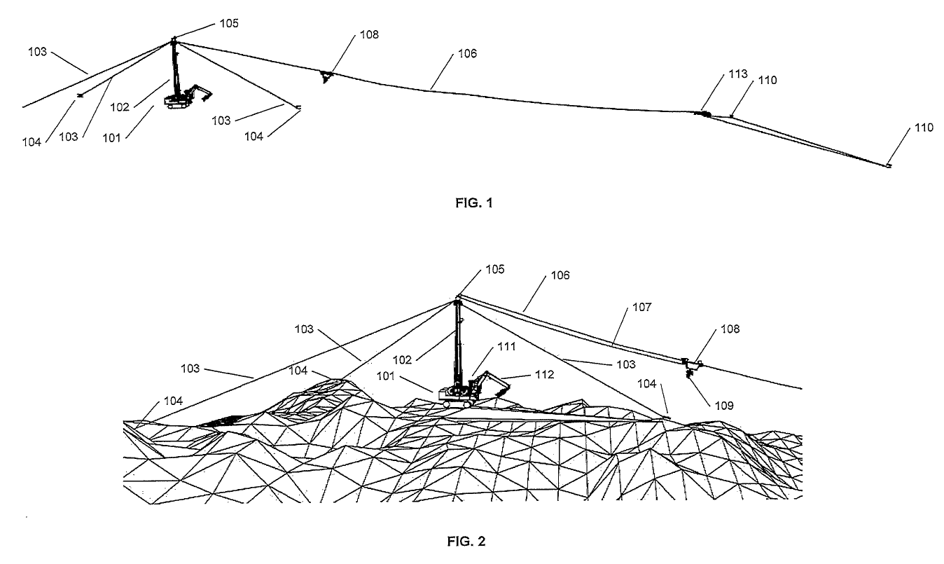

FIG. 1 shows a diagram of a skyline logging system, with FIG. 2 showing a more detailed diagram of the skyline hauler positioning in typical terrain. A hauler 101 is tracked to allow it to access difficult logging sites and has a raisable tower 102 carrying at the top shackles to which anchor cables 103 may be attached for securing to ground anchors, typically tree stumps 104. These prevent the tension of the skyline cable 106 and load from tipping the hauler over. The top of the tower also carries pulleys 105 to allow reeling in and out from one or more winches in the hauler the skyline cable and other working ropes. A hauler may, for instance, have winches for the skyline, the mainline, the haulback feed and the haulback return. Preferably the hauler is above the logging site as this allows shotgunning the carriage down the skyline to pick up a load and does not require careful control of heavy downhill loads.

The hauler 101 may have a drivers cab 111 or may be remotely controlled and may have a grappler 112 to assist in stacking timber when carried to the hauler on the skyline cable 106. The operator may control the loads on the skyline cable and communicates with the loggers in the road by radio or sound signals on a horn.

Sometimes control passes to an in-field operative for the grappling and choking phase then reverts to the operator of the hauler after the load has automatically returned to a spot just before the hauler. In this case an operator in perhaps a separate unloading excavator may take over control.

The hauler 101 can have the tower 102 and drivers cab 111 on a turntable platform, allowing rotation of the entire rig in place on the tracks or wheels, but this is restricted if the tower 102 is guyed since it becomes impossible to easily rotate the tower. It is proposed to provide a central rotatable turntable platform mounting the tower 102 and an outer rotatable platform mounting the drivers cab 111 and grapple. In this way each may be independently rotated allowing the driver the freedom to place stems anywhere around the hauler.

The skyline cable has a carriage 108 which rides on the cable and the carriage may have a controllable grapple 109 (FIG. 2) to hold and bunch stems or it may have choker strops which may be attached to logs to allow them to be dragged back to the hauler. To allow dragging the carriage 108 may be self-powered by a controllable inbuilt engine driving the sheaves which ride on the skyline 106 or there may be a mainline 107 with which the hauler driver drags the carriage to the loader.

The skyline 106 is normally attached at the tail end to a tree stump or to a standing stem, but FIG. 1 shows a variation in which a loop cable attached to stumps 110 passes through a tailhold capstan at a suspended skyline tailhold anchor 113, better described with reference to FIG. 10.

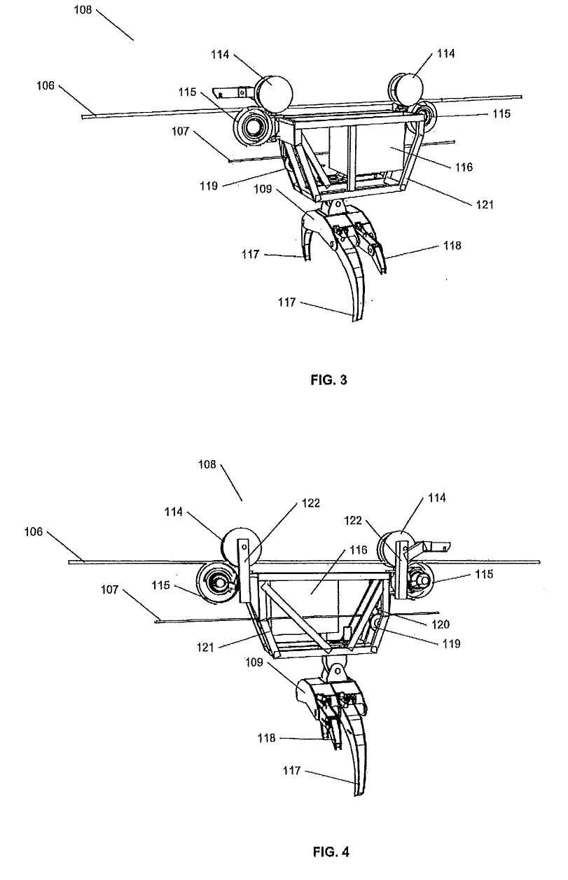

FIGS. 3 and 4 show carriage 108 suspended on skyline cable 106 by sheaves 114. The sheaves have a central groove to capture skyline 106. Sheaves 114 have outer flanges which define the edges of a cylindrical surface on both sides of the central groove. An engine 116 within the carriage can supply hydraulic power to wheels 115 which can engage the skyline cable 106 from below, allowing the engine 116 to power the carriage along the skyline cable or to brake the carriage against movement along the skyline cable 106. The sheaves 114 and wheels 115 may be attached to uprights 122 which are pivoted to allow pivoting of the sheaves and wheels about a vertical axis.

Wheels 115 are actuable to and from engagement with skyline cable 106 and may be of rubber engaging under considerable pressure against the cable 106 and sheaves 114, thus generating considerable deformation friction. Because some movement of the wheel surface is still required for coping with jacks and other irregularities a pneumatic tyre may be used as a wheel 115. In tests a single driven tyre at 90 psi provided 700 Kg of tractive effort in any conditions. Preferably the tyre is a high pressure tyre such as an aircraft tyre from a high wheel loading aircraft type. If more traction is required then more than a single wheel 115 and sheave 114 on each end of the carriage may be provided. This allows a powered carriage to move appreciable loads while still having a skyline cable which does not require a convoluted path through the carriage to achieve the required driving friction level. This in turn allows easy passage past a jack.

A mainline cable 107 may be provided, normally passing through the carriage to allow the end to be used for attaching stems, but with a swaged end 119 to bind the mainline cable 107 against a stop if the carriage 109 is to be hauled by the hauler.

The engine 116 may also supply power to rotate grappler 109 and to separately control bunching arms 117 and grappler arms 118. Control of all the carriage functions may be by radio control from either the hauler operator or by a controller in the road with assistance from a camera either on the carriage or attached to a separate small carriage on the skyline. The camera carriage too may be self-powered, typically by a battery supply.

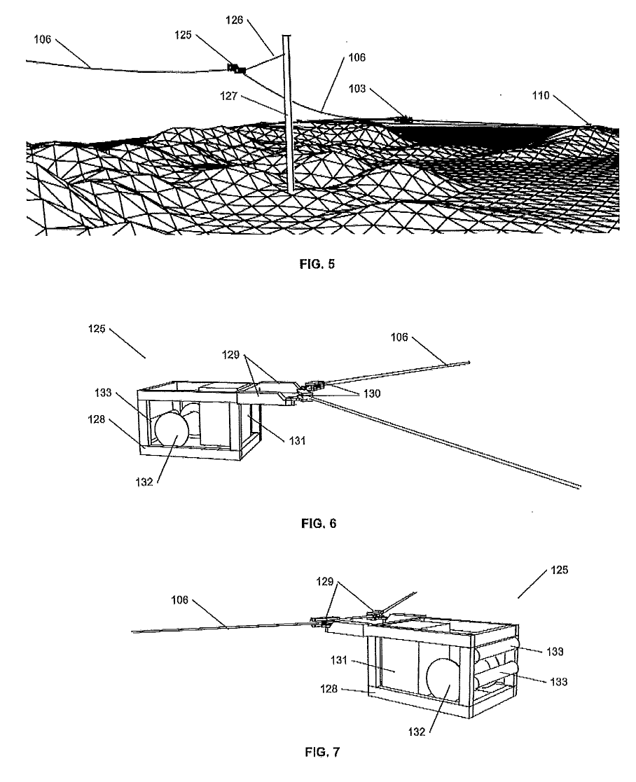

FIG. 5 shows a variation of the skyline system in which the skyline is diverted sideways around a lateral deflection jack to widen the road accessible. Upright jacks are in common use in skyline systems to raise the skyline cable clear of the terrain. Such jacks normally consist of a sheave at tip of a J-shaped support. The upper shank of the J is supported by a standing trunk and the sheave at the tip of the J supports the skyline. A carriage with sheaves open on one side at the top and a gap below allows the carriage to pass over the jack, however the amount of lateral movement of a skyline provided by an upright jack is severely limited because the sheave support will contact the carriage but such jacks are usable for small deflection angles.

FIG. 5 shows a skyline cable 106 and a lateral deflection jack 125 pulled towards standing stem 127 by cable 126. The jack may be depressed with respect to the skyline 106 or it may also raise skyline 126 but its principal use is to deflect the skyline cable 106 sideways.

FIGS. 6 and 7 show an example of such a jack 125 where frame 128 includes a motor 131 which may be remotely controlled to operate winch drum 132. The winch drum winds a rope (not shown) which passes through rollers 133 and is secured to an anchor such as stem 127 of FIG. 5. The tension on the winch rope controls the amount of lateral deflection of the skyline cable 106. The skyline cable passes through shoes 130 pivotally supported on frame arms 129. The shoes may incorporate sheaves to allow easy movement of the skyline cable through them if necessary.

The deflection of the skyline cable may be increased temporarily to allow grappling a stem, but returned to a less deviated path before moving the stem far in order to remain within safe working load of the skyline cable 106.

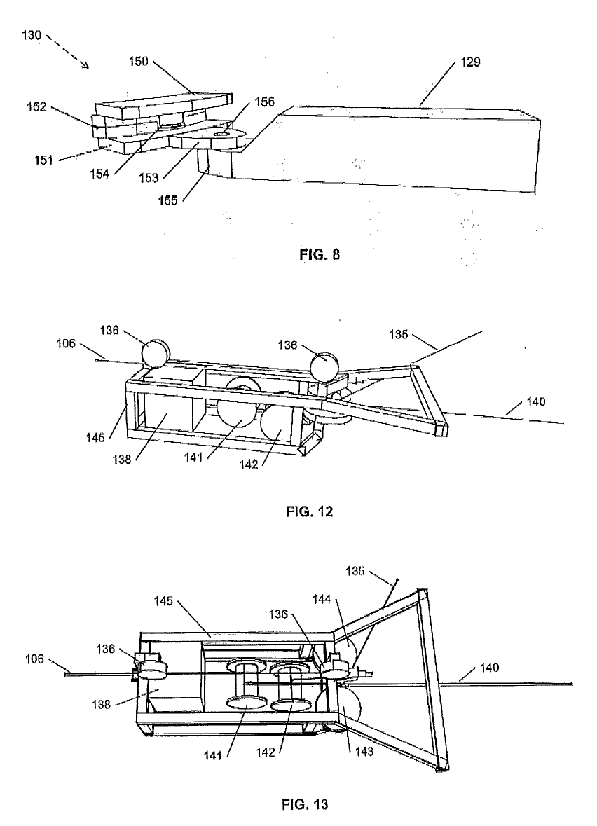

FIG. 8 shows shoes 130 consisting of top plate 150, bottom plate 151 and spacing and wear plates 152. A sheave 154 may be encased within the wear plates to allow the skyline cable to be passed across the shoe with minimal friction. The shoe is pivotally affixed to a frame arm 129 at projection 155 by a flush pin 156.

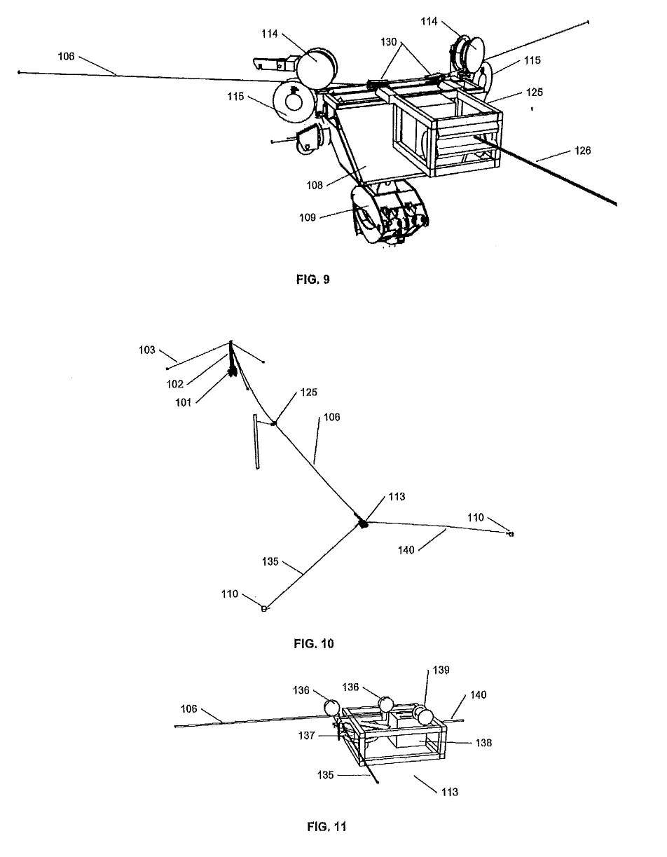

FIG. 9 shows a carriage 108 in transit across a lateral deflection jack 125. Shoes 130 are of low enough profile that they have passed between sheave 114 and wheel 115 and are sized to fit between the flanges of wheels 115 and sheaves 114 and engage the cylindrical surface of the sheave 114. This ensures that the carriage sheaves cannot derail in their passage.

The lateral deflection jack 125 is sized to just clear the carriage container. The result is that if the jack tail anchor 126 is slacked off and removed from its anchor point when a carriage is halted in transit as in FIG. 8 the jack 125 will bind against carriage 108. The skyline will revert to its normal route and the carriage can transport the lateral deflection jack 125 to a new location for attachment to a new anchor. Tightening the jack winch will then tension the skyline sideways, lifting the lateral deflection jack clear of the carriage and allowing the carriage to transit the jack 125.

FIG. 10 shows the tail of the skyline 106. A mobile tailhold 113 is attached to tailhold cables 135, 140 anchored on each side at 110. The mobile tailhold is shown in FIG. 10 and consists of a frame with sheaves 136 allowing it to travel on skyline cable 106 and includes a lock to lock it in place on the skyline cable. Typically the mobile tailhold with a skyline extended to it is placed near an anchor 110 and a tail rope 140 is extended to the anchor. The tail rope can then be tensioned to pull the mobile tailhold towards the anchor so that eventually the skyline can be fully tensioned. The skyline may be directly connected to the anchor 110 or the mobile tailhold may act a mobile anchor with the opportunity to connect to a second anchor via cable 135. Capstan 137 on the mobile tailhold, capable of being driven by motor 138 may be rotated to advance the mobile tailhold between the two anchors 110. In this way the width of the road may be extended at the tail end of the skyline without providing many separate tail anchors. The tailhold may be considered mobile if it is translatable in position while in operation.

When a road is worked out for the whole width of the available movement of the mobile tailhold 113 it is grounded near an anchor 110 by relaxing the skyline, the tailhold cable removed from the other anchor 110 and extended past the remaining anchor to a new anchor. The skyline is again tensioned to lift the mobile tailhold providing a new road width for processing with very little manual labour.

Other combinations of ropes may be used to position the mobile tailhold, for instance given a single fixed anchor for the skyline cable 106 the mobile tailhold may be run down the skyline to the only tailhold, another laterally placed tailhold anchor established with a tailhold cable from the mobile tailhold and a wider road provided by translating the mobile tailhold laterally. When the available roads are all processed the skyline may revert to a single anchor, the mobile tailhold can be pulled back to the hauler with the mainline, and the skyline then be retrieved.

The mobile tailhold itself may have varying combinations of rope handling gear to allow enhanced operations, for instance the tail hold shown in FIG. 11 has a single capstan, a single winch, and skyline supports but variations may include twin winches or a double capstan. FIGS. 12 and 13 show a version with a frame 145 which has two winches 141, 142 running through horizontal sheaves 143, 144 to laterally spaced anchors. Such variations allow the tailhold to be moved to different positions more readily and may also allow the mobile tailhold to perform small yarding operations to move stems to within reach of the skyline.

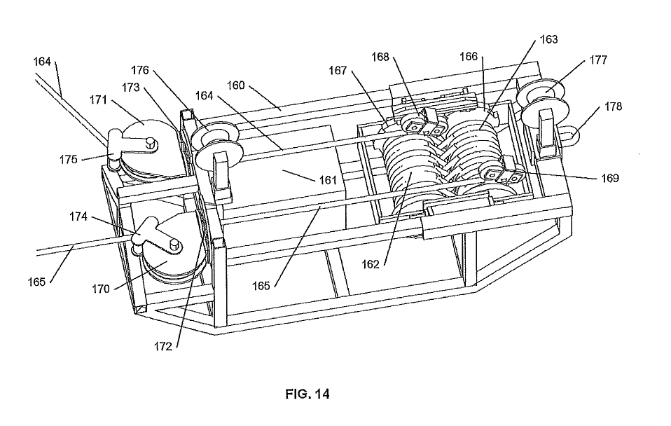

FIG. 14 shows a mobile tailhold variation in which a tub frame 160 has a powered hydraulic unit 161 which may drive two counter-rotating winch drums 162, 163 which are wrapped by a single cable 164 with two ends 164 and 165. The winch drums are hydraulically driven and are synchronised by interengaging gears 167, 168. The multiple wraps of cable 164 around the two drums provides good purchase on the cable to give a good winching ability in either direction. Brakes 168, 169 may be applied to the cable to hold it in one position.

The cable exits through tiltable sheaves 170, 171 through fairleads 174, 175 so that the sheaves will cope with comparatively large horizontal and vertical deflection of the cable ends 164, 165. Fairleads 174, 175 may have deflection sensors so that if the divergence of a cable end is too high an alarm is tripped and the winch stopped.

In use a skyline cable may be fixed to eye 178. Sheaves 176 and 177 may be provided to allow the mobile tailhold to be transported on the skyline when that is secured to a fixed anchor point for initial location or retrieval.

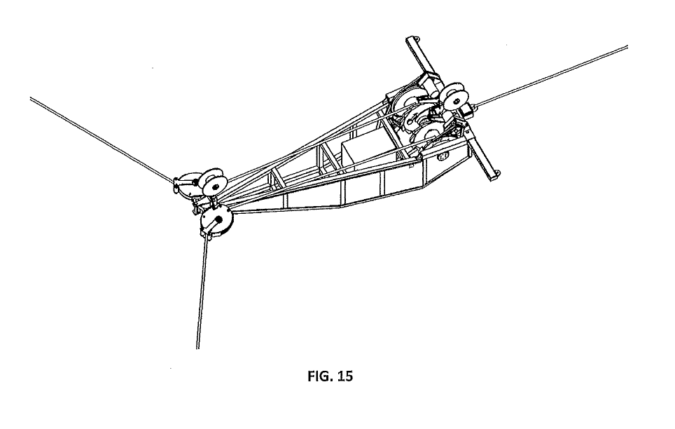

FIG. 15 shows a variation of a two winch tailhold in which a tub frame 180 has a powered hydraulic unit 181 and two winch drums 182, 185 which are driven respectively by hydraulic motors 183 and 186 via chain drives 184, 187. Pawl stops 188, 189 are provided to brake the winch drums. Cables 190, 191 are wound on their respective winch drums 182, 185. The cables 190, 191 exit the mobile tailhold via sheaves 194, 195 which are flexibly mounted by chain links 196.

Eye 199 is attached to the skyline cable 200 and additional outrigger arms with eyes 201, 202 may be mounted on the tub 180 to provide additional securing points for other cables.

In deploying such a mobile tailhold a skyline is deployed to a fixed anchor point from a hauler, the skyline is relaxed and a mobile tailhold placed on the skyline at the hauler. The skyline is tensioned and the mobile tailhold mainlined out to the fixed anchor point where the skyline is again relaxed, connected to the skyline eye on the mobile tailhold, and a tail on the tail hold paid out and connected to the fixed anchor point.

The skyline is again tensioned, lifting the mobile tailhold from the ground to an aerial position and allowing a second tail from the tail hold to be paid out and attached to a laterally located anchor point. The mobile tailhold can now be translated aerially laterally between the two fixed anchor points by paying out one tail and pulling in the other thus moving the skyline end laterally. When the tailhold needs to be moved further laterally it can be grounded at one extent of its travel, the nearest of the anchor point tails removed from the anchor and placed laterally further away while the other is retrieved from the other anchor point and placed on the vacated anchor point. The skyline can then be retensioned to lift the mobile tail hold again.

Control of the functions of the mobile tailholds may be shared between the hauler operator and a controller in the road.

The hauler shown is a track based hauler with a separate controllable grapple, but haulers with only a tower, or on wheeled self-powered platforms or trailers may be used.

### Variations

While the invention is described in relation to a skyline logging system with only a skyline and a mainline it is equally applicable to a system with skyline, mainline and haulbacks.

The lateral deflection jack is described as using flanged cylindrical sheaves with a cable groove but other configurations of sheave and jack plates may be used, the requirement being that the jack will retain the skyline cable so long as the jack tail is under tension, and that the carriage on the skyline can override the jack.

The carriage, lateral deflection jack and mobile tailhold are all described as having engines to drive wheels, winches or capstans. These engines may be small diesel/hydraulic engines, battery driven electric/hydraulic motors or they may be various combinations of haulback or mainline powered gearing. Any method of providing the required motive power is satisfactory. The mobile tailholds may be used to vary the position of a lateral deflection jack by shifting it along the skyline path. Since loads at the lateral deflection jack are not as extreme as those at a tailhold a lighter version of the tailhold may be used. To further reduce the weight of a light tailhold or a lateral deflection jack the anchor ropes or cables may be synthetic, for instance of Kevlar.

Control of the mobile tailhold is preferably by radio for functions such as winch control or winch braking, with detection of parameters such as tail cable overload.

Because the skyline carriage may well be operating out of sight of the hauler operator the control system will typically be based on secure radio and video links with the transmitters for these forming part of the structure of equipment such as cameras, jacks and carriages. A ground operator in the skyline road may be assisted by video glasses and control gloves for the equipment linked in to this system.

While the system is described as delivering stems to a yarder it may equally be used to deliver stems from a yarder to a remote loading point.

A person skilled in the art will realise that other mechanisms may provide the required operations and may be substituted as required.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the controllers for the devices may vary dependent on the particular application for which it is used without variation in the spirit and scope of the present invention.

In addition, although the preferred embodiments described herein are directed to a tree felling head, it will be appreciated by those skilled in the art that variations and modifications are possible within the scope of the appended claims.

1. A mobile tailhold for a skyline logging system, the mobile tailhold having at least two mobile tailhold powered winchable cable tails, the cable tails being winchable by at least one mobile tailhold mounted winch, the cable tails each being attachable to an anchoring point such that the mobile tailhold can be positioned relative to the anchor points by winching the cable tails with the at least one mobile tailhold mounted winch.

2. A mobile tailhold for a skyline logging system as claimed in claim 1 wherein the mobile tailhold is attached to a skyline cable and is lifted above the ground in use.

3. A mobile tailhold for a skyline logging system as claimed in claim 2 wherein the mobile tailhold is fixedly attached to a skyline cable as a tailhold.

4. A mobile tailhold for a skyline logging system as claimed in claim 2 wherein the mobile tailhold is movably attached to a skyline cable.

5. A mobile tailhold for a skyline logging system as claimed in claim 2 wherein the mobile tailhold is movable aerially laterally of the skyline cable by shortening one of the mobile tailhold powered winchable cable tails when attached to an anchor point and lengthening another of the mobile tailhold powered winchable cable tails when attached to an anchor point.

6. A mobile tailhold for a skyline logging system as claimed in claim 1 wherein the at least one mobile tailhold mounted winch is a dual drum capstan winch in which the capstan drums counter-rotate and a cable is wrapped in opposing directions around each of the dual drums to provide the winchable cable tails.

7. A mobile tailhold for a skyline logging system as claimed in claim 5 wherein the drums of the dual drum capstan are geared to counter-rotate synchronously.

8. A mobile tailhold for a skyline logging system as claimed in claim 1 wherein the winchable cable tails are winched by separate mobile tailhold powered winches.

9. A mobile tailhold for a skyline logging system as claimed in claim 1 wherein the winchable cable tails exit the tailhold through fairleads which fairleads monitor the cable tail exit angle.

10. A skyline logging system having at least a skyline cable supported between a hauler and an aerial mobile tailhold, the mobile tailhold being anchorable to at least two separate tail anchor points by cable tails, the mobile tailhold having at least one mobile tailhold powered winch adapted to separately pay out or pull in the cable tails, the mobile tailhold being movable aerially from adjacent one anchor point to adjacent another anchor point by paying out one cable tail and pulling in another cable tail.

11. A skyline logging system as claimed in claim 10 wherein the mobile tailhold has two mobile tailhold powered winches separately controlling the tension in cable tails to two tail anchor points.

12. A skyline logging system as claimed in claim 10 wherein the mobile tailhold has a single anchoring cable with a cable tail extending to each of two different tail anchor points and has a mobile tailhold powered capstan around which an intermediate portion of the cable is wrapped.

13. A skyline logging system as claimed in claim 10 wherein the tailhold has a capstan having two capstan drums and the cable wraps both drums at least once.

14. A skyline logging system as claimed in claim 13 wherein the two capstan drums of the tailhold counter-rotate, are geared to counter-rotate synchronously and the cable wraps in opposite directions around each drum.

15. A skyline logging system as claimed in claim 10 wherein the mobile tailhold is supportable from the skyline cable and is adapted to travel along the skyline cable.

16. A lateral deflection jack for a cable logging system, the jack having a flame capable of being attached to an anchor point, at least one pivoted cable receiving shoe pivoted from the frame, the pivotable cable receiving shoe having spaced upper and lower plates, the upper plate having a substantially flat upper surface, the space between the upper and lower plates defining a cable receiving recess, the upper plate being over-rideable by at least one supporting sheave of a carriage, the carriage running on a cable received in the space between the upper and lower plates.
